(19) United States
(12) Patent Application Publication
(10) Pub. No.: US 2016/0131915 A1
(43) Pub. Date: May 12, 2016

(54) DEVICE CASE INCORPORATING A READING LENS

(71) Applicant: ES EM GEE PTY LTD, Christies Beach, S.A. (AU)

(72) Inventor: Stephen Matthew Grealy, Christies Beach, S.A. (AU)

(21) Appl. No.: 14/786,532

(22) PCT Filed: Apr. 28, 2014
(86) PCT No.: PCT/AU2014/000474

§ 371 Date: Oct. 26, 2015

(30) Foreign Application Priority Data
Apr. 29, 2013 (AU) 2013901492

(51) Int. Cl. G02B 27/02; G02B 7/14; G02B 7/02

(52) U.S. Cl. CPC G02B 27/028; G02B 27/021; G02B 7/023; G02B 7/026; G02B 7/14

(57) ABSTRACT

A protective case for a portable electronic device including a reading assistance lens assembly, and a case housing. The reading assistance lens assembly includes a housing having a front, back and side perimeter, and at least one lens associated with said housing. The case housing includes a frame, and an extension/retraction mechanism attached to the frame. The frame is configured to provide the reading assistance lens assembly to be extended and recessed within the protective case. The reading assistance lens assembly can be deployed by a sliding assembly, a biased hinge assembly, or a biased spring loaded assembly.

### BACKGROUND OF THE INVENTION

1. Technical Field

The present invention relates to a portable electronic device protective case that has incorporated into its design a frame and mechanism to facilitate the housing of an extendable and retractable reading assistance lens assembly.

The present invention primarily relates to portable electronic devices such cellphone/mobile phones, iPhone™ communication devices, personal digital assistant devices and the like. More particularly, it relates to hard protective carrying cases for such devices, which have enhanced capabilities beyond their protective properties.

2. Background Art

Protective cases for personal electronic devices are well known and in common use. Personal electronic communications devices that consumers carry very usually on their person are subject to damage through normal use. To this end, prior art has developed a variety of protective cases in which the portable electronic device is housed when carried by the consumer.

There are three things that virtually everyone in the developed world will have on their person (or within reach) at all times: their keys, their wallet/purse/Credit Card and their mobile phone. The other critically important thing to have on hand for a great many people is their reading glasses.

Those people requiring magnification assistance for comfortable reading will invariably have their (very likely expensive) prescription reading glasses as diagnosed and supplied by an Optometrist. In addition to their expensive prescription glasses they will have any number of cheap non-prescription magnified reading assistance glasses distributed about their home and office or car. Despite the number of spare reading glasses secreted about their usual environs it is when those clear vision challenged persons are away from their usual environs that the necessity of being able to read a single line on a menu or a single word on a label that the absence of their reading glasses is most distressing.

The inevitable situation then occurs whereby the use of reading glasses would be very convenient to quickly read a menu or wine label or other small typeface written material. Carrying your reading glasses everywhere is a burden that those that need that reading assistance have to bear. Given the opportunity not to have to bother is an option that will be taken up by many.

It is therefore the object of this invention to overcome those irritating, embarrassing and unforeseen moments of reading assistance absence.

Therefore, a need exists for a new and improved device case incorporating a reading lens that can be used for providing a deployable reading lens with a device case. In this regard, the present invention substantially fulfills this need. In this respect, the device case incorporating a reading lens according to the present invention substantially departs from the conventional concepts and designs of the prior art, and in doing so provide an apparatus primarily developed for the purpose of providing a deployable reading lens with a device case.

### SUMMARY OF INVENTION

In view of the foregoing disadvantages inherent in the known types of protective cases for personal electronic devices now present in the prior art, the present invention provides an improved device case incorporating a reading lens, and overcomes the above-mentioned disadvantages and drawbacks of the prior art. As such, the general purpose of the present invention, which will be described subsequently in greater detail, is to provide a new and improved device case incorporating a reading lens and method which has all the advantages of the prior art mentioned heretofore and many novel features that result in a device case incorporating a reading lens which is not anticipated, rendered obvious, suggested, or even implied by the prior art, either alone or in any combination thereof.

To attain this, the present invention essentially comprises a protective case for a portable electronic device including a reading assistance lens assembly, and a case housing. The reading assistance lens assembly includes a housing having a front, back and side perimeter, and at least one lens associated with said housing. The case housing includes a frame, and an extension/retraction mechanism attached to the frame. The frame is configured to provide the reading assistance lens assembly to be extended and recessed within the protective case. The reading assistance lens assembly can be deployed by a sliding assembly or a biased hinge assembly or a spring loaded, switch operated assembly or a manually operated rotating arm assembly.

There has thus been outlined, rather broadly, the more important features of the invention in order that the detailed description thereof that follows may be better understood and in order that the present contribution to the art may be better appreciated.

The case housing of the present invention may also include a movable switch, a pivot point, and a spring element. The switch can be moveable in and out of contact with the reading assistance lens assembly. The pivot point can be rotatably coupled to the reading assistance lens assembly. The spring element can be in biased contact with the reading assistance lens assembly so as to bias the reading assistance lens assembly about the pivot point when the switch is moved out of contact with the reading assistance lens assembly.

The case housing of the present invention may also include a moveable button operatively associated with a flexible arm that is operatively associated with a hook, a coil spring, and a pivot point. The reading assistance lens assembly may also include an eye. With the hook configured to be releasable engageable with the eye upon activation of the button. With the pivot point being rotatably coupled to the reading assistance lens assembly. With the coil spring configured to be in biased contact with the reading assistance lens assembly so as to bias the reading assistance lens assembly about the pivot point when the hook is released from said eye of the reading assistance lens assembly.

There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved device case incorporating a reading lens that has all of the advantages of the prior art protective cases for personal electronic devices and none of the disadvantages.

It is another object of the present invention to provide a new and improved device case incorporating a reading lens that may be easily and efficiently manufactured and marketed.

An even further object of the present invention is to provide a new and improved device case incorporating a reading lens that has a low cost of manufacture with regard to both materials and labor, and which accordingly is then susceptible of low prices of sale to the consuming public, thereby making such device case incorporating a reading lens economically available to the buying public.

Still another object of the present invention is to provide a new device case incorporating a reading lens that provides in the apparatuses and methods of the prior art some of the advantages thereof, while simultaneously overcoming some of the disadvantages normally associated therewith.

Therefore in one form of the invention there is proposed a reading assistance lens set into the back of a portable electronic device protective case, including:

a lens of a size and rigidity to be able to be machined into a shape so as to be hinged into the case material;

a lens that is of a magnifying or dioptre strength so as to be useful to a person requiring same;

a lens that is of a minimal thickness so as to be able to be slid away into the recess in the case to keep it protected and secure;

a lens that comprises two lenses set slightly apart to facilitate viewing through both eyes; and a lens comprising a single eye lens or twin eye lens configuration with a nose bridge for comfort and focal length assistance.

Alternatively, the lens being drilled and pivoted as a means of attachment to the case.

Alternatively, the lens being a loose item that can be withdrawn entirely out of the back of the case or being a loose item that is secured with an extended and then retracted action.

The case being supplied with a variety of magnification dioptre strength lens for the user to choose from.

The lens frame assembly can be supplied sans lens giving the user the option to have their own prescription lens fitted by their optometrist.

The lens being lightweight but strong enough to withstand constant use.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIGS. 1a and 1b are a planar view of an embodiment of the reading assistance lens assembly base with a single lens design and a twin lens design along with a nose-bridge.

FIGS. 2a and 2b are a rear planar view of the reading assistance lens assembly base with a single lens design and a twin lens design.

FIG. 3 is a base end planar view of the portable electronic device in hard case with shoulders maintaining a central housing for a reading assistance lens assembly base.

FIG. 4 is a planar view of the reading assistance lens assembly base with a single lens option housed inside the protective case.

FIG. 5 is a planar view of the reading assistance lens assembly base with a single lens in a ready to use position outside an otherwise housed position inside the protective case.

FIGS. 6a, 6b and 6c collectively are an assembled planar view and an exploded planar view of a base plate and a top plate of the protective case.

FIGS. 7a, and 7c are an exploded planar view and a side planar view of the reading assistance lens assembly base with a twin lens design along with a nose-bridge. The coil spring 20 can be seen in FIG. 7b.

FIG. 8a is a front planar view of the base plate. FIG. 8b is a view of the reading assistance lens assembly base housed and attached to the base plate including a release mechanism button.

FIG. 8c is a planar view of the reading assistance lens assembly base with a twin lens in the extended and ready to use position outside an otherwise housed position inside the protective case.

FIG. 9a describes an assembled side view of the base plate, reading assistance assembly and top plate as attached to a device case. FIGS. 9b, 9c and 9d collectively illustrate an exploded side view of the base plate, the reading assistance lens assembly base, and the top plate.

FIGS. 10a and 10b together shows an exploded planar view of the reading lens assembly with pinion and coil spring loaded rack on sliding track with switch and switch track.

FIG. 11a is a planar view of the base plate. FIG. 11b is a planar view of the top plate of the protective case. Also seen here in 11c are the rack and the rack track.

FIGS. 12a and 12b collectively are a front planar view of the reading assistance lens assembly base attached to the base plate including the spring loaded rack and pinion with switch release mechanism, showing both the extended and retracted positions. Also shown in 12c and 12d is the exploded view of the reading lens assembly with pinion and coil spring loaded rack on sliding track with switch and switch track.

FIGS. 13b and 13c is exploded planar view of the pinion and channel plus the reading lens assembly frame shown unattached to the channel. Also shown in 13a is the end view of the channel and lens assembly frame.

FIG. 13d is a planar view of the pinion and channel with the reading lens assembly frame inserted into the channel; also shown in FIG. 13d is the reading lens assembly frame locked into the channel ready for retracting into its case.

FIG. 14a through to 14k shows the back planar and side profile views of one of the embodiments of the LenZcase™ wherein the case holding the reading assistance lens is attached to any electronic device case using double sided pressure tape.

The same reference numerals refer to the same parts throughout the various figures.

### DESCRIPTION OF EMBODIMENTS

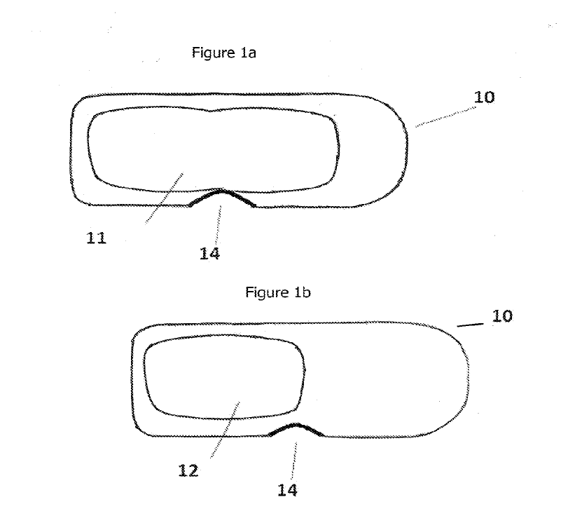

Referring now to the drawings and particularly to FIGS. 1-14k, an embodiment of the device case incorporating a reading lens of the present invention is shown and generally designated by the reference numeral 10.

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the embodiments and the following description to refer to the same and like parts.

The present invention relates to a portable, self-contained lens for the assistance to reading small printed material in the absence of the users normal reading glasses.

An important feature of the invention is that the user may not normally require reading glasses but will use the inherent magnification characteristic of the lens in times of bad light or exceptionally small print.

Another important feature of the preferred embodiment is the ability for the said lens to withdraw entirely back into its recess during non-use and for protection.

In another embodiment the method of attachment will be via a pivot point machined into the case and lens.

In another embodiment the method of withdrawing the lens would be by spring loaded action release with a switch.

In another embodiment the method of use would be by detaching the reading lens assembly from its deployed frame and thereafter use, re-attaching into its frame and retracting back into its case.

In another embodiment the reading assistance lens is protected within its own hard case with attachment to any electronic device by way of double sided pressure tape.

In FIG. 1b, a reading assistance lens assembly base 10 with a single lens 12, and a twin lens design 11, as seen in FIG. 1a, with both featuring a nose-bridge 14, are illustrated and described.

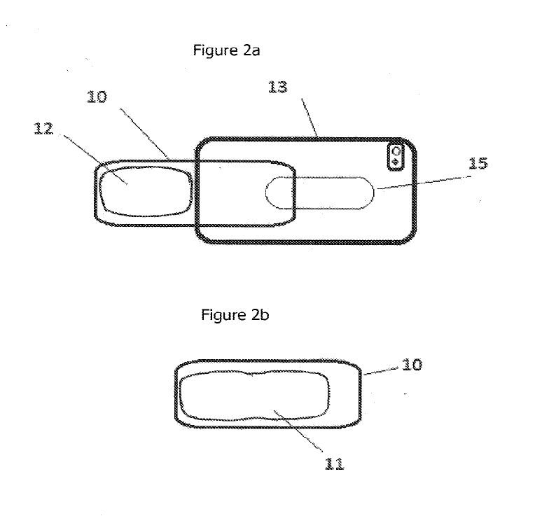

In FIG. 2a is seen the reading assistance lens assembly base 10 with the single lens design 12 and the twin lens design 11 as seen in FIG. 2b, is illustrated and described. Also seen is a rear view of the portable electronic device hard case 13 with a slide window 15 for extraction of reading lens assembly 10. The thumb slide window 15 is configured to allow a user to slide the reading assistance lens assembly base 10 out from the hard case 13 by using a thumb or finger to push against the reading assistance lens assembly base 10. It can be appreciated that the reading assistance lens assembly base 10 can be slidably received in a groove, track or any other sliding arrangement so as to allow the reading assistance lens assembly base 10 to slide out of the hard case 13 so that the lens 11, 12 is viewable by the user from exterior of the hard case 13.

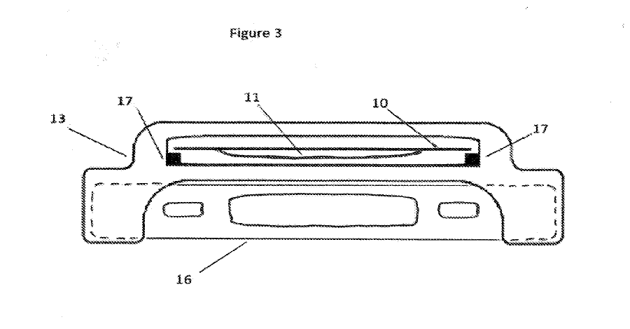

In FIG. 3, a portable electronic device 16 received in the hard case 13, is illustrated and described. The hard case 13 includes shoulders 17 that maintain a central location for the reading assistance lens assembly base 10 with the twin lens 11 showing convex downwards being in a protected zone between the shoulders 17. The assembly seen is housed into the case 13. The hard case 13 can include an extended portion featuring an opening that slidably receives the reading assistance lens assembly base 10 therethrough. The shoulders 17 can be located in the opening or any portion of the hard case 13 that receives the reading assistance lens assembly base 10.

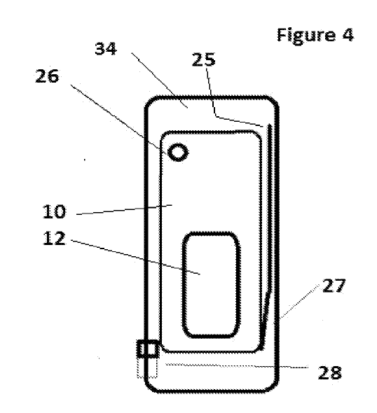

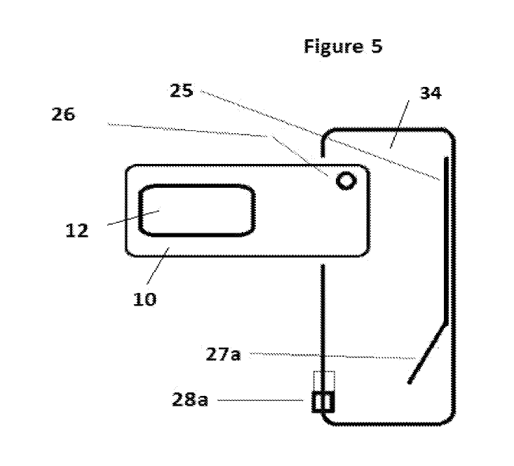

In FIGS. 4 and 5, an alternate embodiment of the protective case, is illustrated and described. With regard to FIG. 4, the alternate embodiment protective case includes a base plate 34 that is attachable to the portable electronic device and is configured to house therein the reading assistance lens assembly base 10 with the single lens 12 option. The reading assistance lens assembly base 10 is held against a bar spring 25 by virtue of a locking and releasing mechanism 28. The lens assembly 10 rotates on a pivot pole or point 26 when released. The pivot point 26 can be attached to the base plate so that the reading assistance lens assembly base 10 is housed in the alternate embodiment protective case and pivotably deployed so that the lens 12 is exterior of the protective case 13 when the locking and releasing mechanism 28 is operated. The bar spring 25 includes a bar spring tail portion 27 that is in contact with the reading assistance lens assembly base 10. The spring tension accumulated in the bar spring tail 27 will thrust the lens assembly 10 out of its housed position within the second alternate embodiment protective case 13. The release switch 28 impedes this action when not activated, and allows this action when moved so as not to be in contact with the reading assistance lens assembly base 10, as best illustrated in FIGS. 4 and 5.

In FIG. 5, the reading assistance lens assembly base 10 with the single lens 12 is in the ready to use position outside its otherwise housed position inside the alternate embodiment protective case 13, is illustrated and described. The bar spring tail 27 can be seen to be now in its relaxed state 27a. The locking/releasing switch 28 is now seen in its open state 28a. The bar spring tail 27 is configured to have a biasing force against the reading assistance lens assembly base 10 so that it pivots about the pivot point 26.

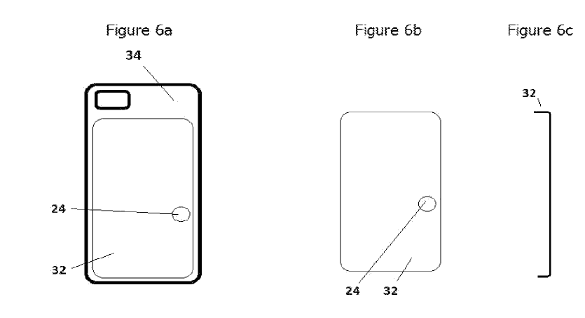

In FIGS. 6-9, an additional alternate embodiment of the protective portable electronic device case is illustrated and described. With regard to FIGS. 6a, 6b, and 6c collectively, the additional alternate embodiment protective case 13 includes a top plate 32 attachable to the base plate 34, with the base plate being attachable to the portable electronic device. The top plate 32 further includes a release mechanism button 24.

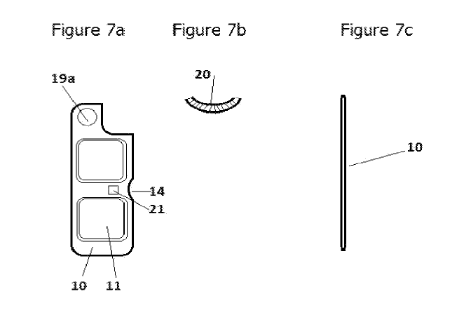

The reading assistance lens assembly base 10, including the twin lens 11, is shown in FIG. 7a featuring a pivot hole 19a, the nose bridge 14, and an eye 21 adjacent the nose bridge. FIG. 7b illustrates the coil spring 20. A notched section can be defined in the lens assembly base 10 adjacent the pivot pole 19a. The eye 21 can be located between the twin lenses 11. FIG. 7c shows the side view of lens assembly base 10.

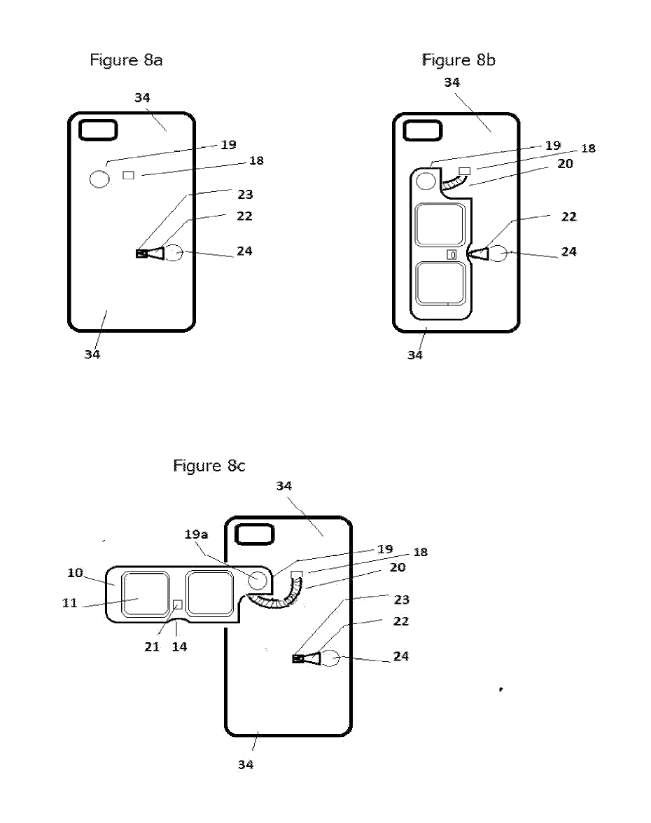

In FIG. 8b, the reading assistance lens assembly base 10 with the twin lens 11 design assembled with the base plate 34, is illustrated and described. In FIG. 8a the base plate 34 further includes a flexible arm 22, a hook 23, and a pivot pole 19. The pivot hole 19a as seen in FIG. 8c is configured to receive the pivot pole 19 thereby allowing the lens assembly base 10 to pivot about the pivot pole 19 to a deployed position exterior of the protective case. When assembled, the lens assembly 10 is attached to the base plate 34 so that the pivot pole 19 is received in the pivot hole 19a, and that the coiled spring 20 is wound around the pivot pole 19 and attached to the lens assembly 10 so as to provide a biasing force to the lens assembly 10 at position 18. In this non-deployed position as seen in FIG. 8b, the lens assembly base 10 is held in situ by the hook 23 which is engageable with the eye 21.

To deploy the lens assembly 10, the release mechanism button 24 is operated which acts upon the flexible arm 22 to pull the hook 23 downwards and out of the eye 21, thereby releasing the lens assembly base 10 and causing the coiled spring 20 tension to rotate out of the housed position to a perpendicular user position. The rotation of the coiled spring 20 acts on the lens assembly 10 which rotates the lens assembly 10 about the pivot pole 19. This can be seen in FIG. 8a. The hook 23 is in operable configuration with a flexible arm 22 and release mechanism button 24.

In FIG. 8c the reading assembly lens 10 can be seen in the deployed position with the coil spring tension unleashed and holding the reading assembly perpendicular to the case.

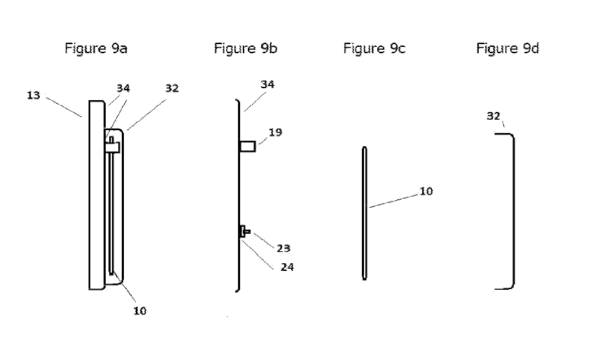

FIG. 9a shows the side view of the device hard case 13, the top plate 32 attached to the base plate 34 so as to cover the lens assembly base 10. Showing inside in between the base plate 34 and the top plate 32 is the lens assembly base 10 and the pivot pole 19. Seen in side profile in FIG. 9b is the base plate 34 with the pivot pole 19, the release mechanism button 24 and the hook 23. FIG. 9c shows the lens assembly base 10 and FIG. 9d shows the unattached top plate 32.

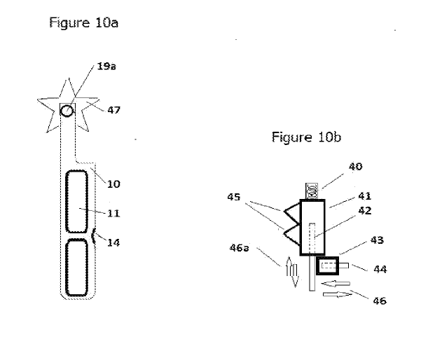

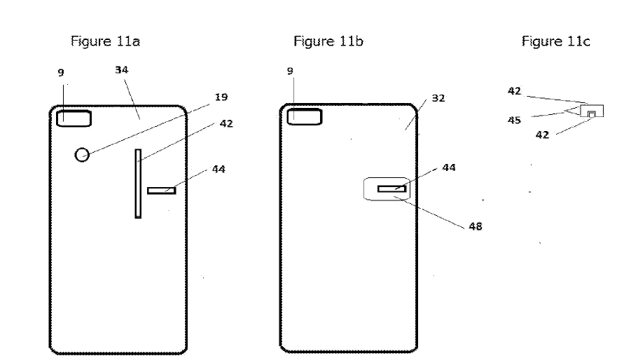

The reading assistance lens assembly base 10, including the twin lens 11, is shown in FIG. 10a featuring a pinion 47. The lens assembly 10 includes a pivot hole 19a, the nose bridge 14. Also, seen in FIG. 10b, is the tensioned coil spring 40 attached to the rack 41 with teeth 45 sliding along the track 42. The switch 43 located on its track 44 is show engaged with the rack 41. 46 and 46a show each the two directions facilitated by the rack and switch tracks respectively.

In FIG. 11a, the base plate 34 is shown with pivot pole 19 and rack and switch tracks 42 and 44 respectively incorporated into the mould. Additionally shown in FIG. 11a is the cut out 9 of base plate 34 for the camera and spot light space. Top plate 32, seen in FIG. 11b also shows switch cut out 48 and switch track 44. Rack 42 with teeth 45 and rack track 42 can be seen in end view profile can be seen in FIG. 11c.

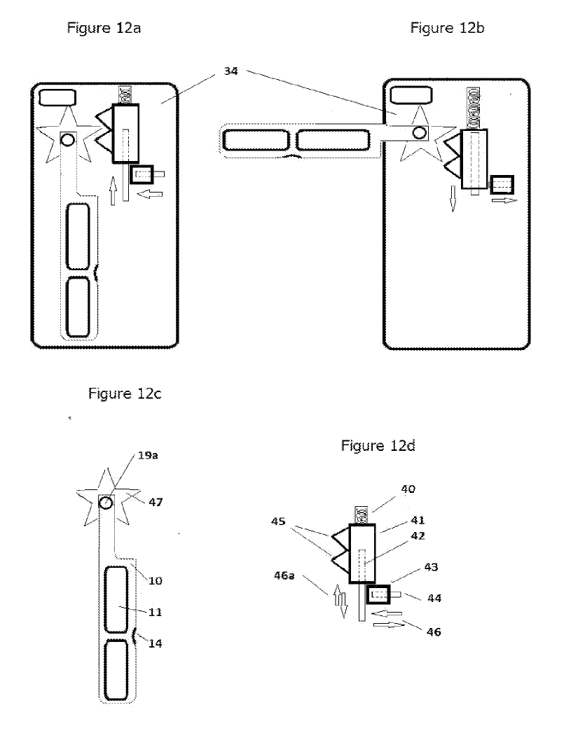

FIGS. 12a and 12b shows the reading lens assembly 10 with rack and pinion with sliding switch embodiment in both the retracted and extended positions. Also seen is FIG. 12c showing the reading assistance lens assembly base 10, including the twin lens 11 attached to the pinion 47 as well as the lens assembly 10 including a pivot hole 19a, and the nose bridge 14. In FIG. 12d the tensioned coil spring 40 can be seen, attached to the rack 41 with teeth 45 sliding along the track 42. The switch 43 located on its track 44 is shown engaged with the rack 41. 46 and 46a indicate each the two directions facilitated by the rack track and switch tracks respectively.

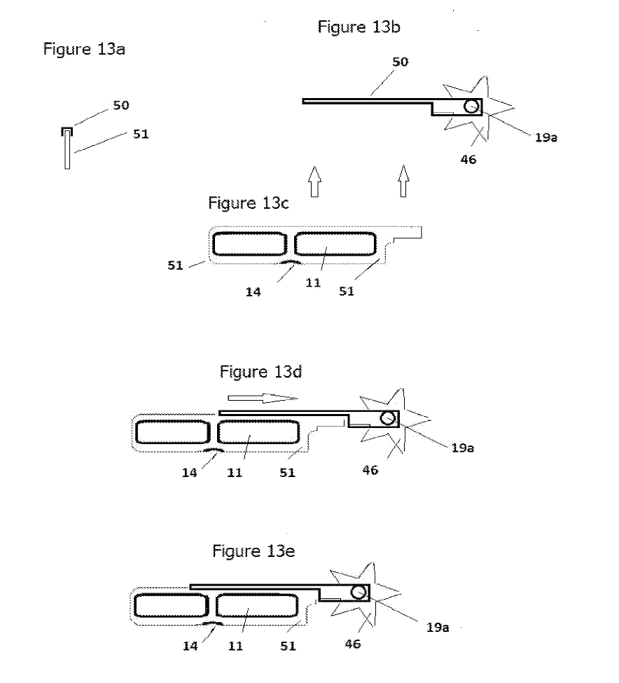

In FIGS. 13a, 13b, 13c, 13d and 13e collectively show the reading lens assembly 51 along with twin lens 11 and nose notch 14 can be seen in three stages of attachment/detachment from channel 50 with pinion 46 and pivot hole 19a. Also seen in FIG. 13a is end profile view of channel 50 and reading lens assembly 51. FIG. 13d shows reading lens assembly 51 first slid into channel 50 before being locked into place as shown in FIG. 13e.

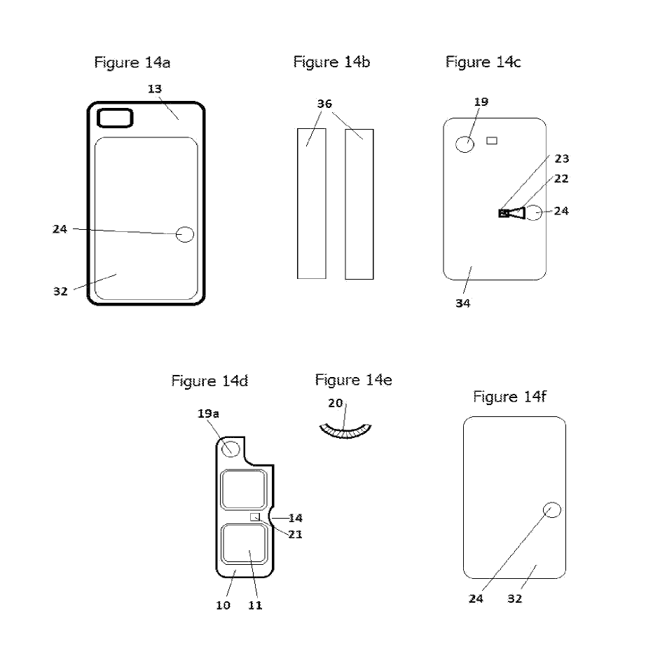

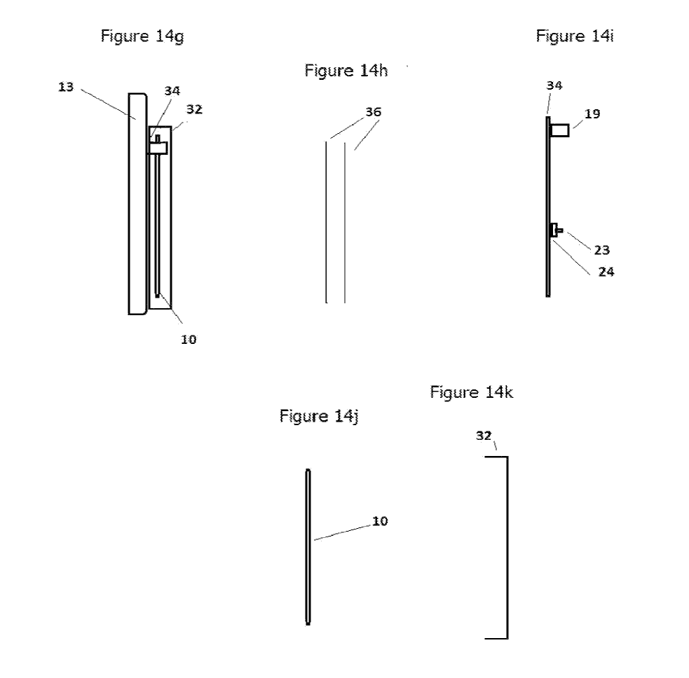

FIGS. 14a, 14b, 14c, 14d, 14e and 14f collectively shows an exploded planar view of the back of a portable electronic device hard case 13, attached is the top plate 32; also showing is release mechanism button 24. Double sided adhesive pressure tape 36 is used to attach base plate 34 to the back of the portable electronic device hard case 13. The Reading Assistance Lens assembly base 10 with twin lens design 11 along with nose-bridge 14 and hook hole 21 is attached to base plate 34 by the pivot pole 19 through pivot hole 19a and coil spring 20. Also seen here housed on the base plate 34 is the release mechanism button 24, the flexible arm 22 and the hook 23. The top plate 32 also shows the release mechanism button 24.

FIGS. 14g, 14h, 14i, 14j and 14k collectively shows an exploded side view of a portable electronic device hard case 13 with attached base plate 34 and connected top plate 32. Specifically FIG. 14h shows the double sided pressure tape 36. Showing inside in between base plate 34 and top plate 32 is the Reading Assistance Lens base 10 and pivot pole 19. On the base plate 34 the pivot pole 19, release mechanism button 24 and hook 23 can be seen in side profile. Also seen is the Reading Assistance Lens base 10 and unattached top plate 32.

The method of withdrawing the lens can be similar to that on a pocket knife; i.e. with a fingernail groove to facilitate grasping and extending thereof or in a spring loaded switch operated switchblade style of extended and retracted action.

In summary the portable electronic device protective case, LenZcase, is a product comprising a standard portable electronic device protective case with access to a reading assistance lens for quick and convenient use in the absence of usual prescription reading glasses.

The present invention relates predominately to assisting those persons who normally use reading glasses but for any number of reasons do not have them available at the time of need.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

While embodiments of the device case incorporating a reading lens have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. And although providing a deployable reading lens with a device case have been described, it should be appreciated that the device case incorporating a reading lens herein described is also suitable for an device cover or apparatus associated with reading.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A protective case for a portable electronic device, said protective case comprising:
a reading assistance lens assembly having a housing including a front, back and side perimeter, and at least one lens associated with said housing; and
a case housing having a frame, and an extension/retraction mechanism attached to said frame, said frame being configured to provide said reading assistance lens assembly to be extended and recessed within said protective case.

2. The protective case of claim 1, wherein said case housing further comprising an opening defined therethrough, said opening being configured to allow access by a user to said reading assistance lens assembly, said reading assistance lens assembly being slidably received in said case housing by an assembly selected from the group consisting of a slide assembly, and a rail assembly.

3. The protective case of claim 1, wherein said case housing further comprising at least two shoulders in a spaced apart relationship, said shoulders being configured to maintain the reading assistance lens assembly base in a central position with the lens being in a protected zone between the shoulders.

4. The protective case of claim 1, wherein said case housing further comprising a locking and releasing mechanism, a pivot point, and a spring element, said locking and releasing mechanism being moveable positionable in and out of contact with said reading assistance lens assembly, said pivot point being rotatably coupled to said reading assistance lens assembly, said spring element being in biased contact with said reading assistance lens assembly so as to bias said reading assistance lens assembly about said pivot point when said locking and releasing mechanism is moved out of contact with said reading assistance lens assembly.

5. The protective case of claim 1, wherein said case housing further comprising: a locking and releasing mechanism operatively associated with a flexible arm that is operatively associated with a hook; a coil spring; and a pivot point;
wherein said reading assistance lens assembly further comprising an eye;
wherein said hook is configured to be releasable engageable with said eye upon activation of said locking and releasing mechanism;
wherein said pivot point being rotatably coupled to said reading assistance lens assembly;
wherein said coil spring is configured to be in biased contact with said reading assistance lens assembly so as to bias said reading assistance lens assembly about said pivot point when said hook is released from said eye of said reading assistance lens assembly.

6. The protective case of claim 1, wherein said case housing further comprising: a locking and releasing mechanism operatively associated with a sliding switch that is operatively associated with a sliding rack; a pinion; a coil spring; and a pivot point;
wherein said reading assistance lens assembly further comprising a pinion;
wherein said rack further comprising a track;
wherein said switch further comprising a track;
wherein said switch is configured to be releasable engageable with said rack upon activation of said locking and releasing mechanism;
wherein said pivot point being rotatably coupled to said reading assistance lens assembly;
wherein said coil spring is configured to be in biased contact with said rack so as to bias said reading assistance lens assembly about said pivot point by way of said rack engaging with said pinion when said switch is moved along said sliding track.

7. The reading assistance lens assembly of claim 1, wherein the assembly includes the option to remove or disengage the current reading assistance lens assembly in order to change to another lens magnification or spare lens as supplied or available.
